(19) United States
(12) Patent Application Publication
(10) Pub. No.: US 2022/0055184 A1
(43) Pub. Date: Feb. 24, 2022

(54) MACHINING SEGMENT FOR THE DRY MACHINING OF CONCRETE MATERIALS

(71) Applicant: Hilti Aktiengesellschaft, Schaan (LI)

(72) Inventors: Marcel SONDEREGGER, Balgach (CH); Cliff TOLDO, Vaduz (LI)

(21) Appl. No.: 17/415,342

(22) PCT Filed: Dec. 20, 2019
(86) PCT No.: PCT/EP2019/025466

§ 371 Date: Jun. 17, 2021

(30) Foreign Application Priority Data
Dec. 31, 2018 (EP) 18216010.1

(51) Int. Cl. B24D 7/06; B28D 1/14; B28D 1/04

(52) U.S. Cl. CPC B24D 7/06; B28D 1/041; B28D 1/146

(57) ABSTRACT

A machining segment for a machining tool which is rotatable in a direction of rotation about an axis of rotation includes an underside where the machining segment is connectable to a basic body of the machining tool by the underside. The machining segment has a machining zone of a matrix material and a plurality of first hard material particles that are disposed in the matrix material in accordance with a defined particle pattern. An upper side of the machining segment, opposite from the underside, is divided into a plurality of machining regions, which include respective ones of the plurality of first hard material particles, and a plurality of matrix regions which are built up from the matrix material. At least one of the plurality of machining regions has with respect to an adjacent matrix region a projection that is greater than 400 μm.

### BACKGROUND AND SUMMARY OF THE INVENTION

The present invention relates to a machining segment for a machining tool and to a machining tool with such a machining segment.

Machining tools, such as core drill bits, saw blades, abrasive disks and cut-off grinding chains, comprise machining segments that are attached to a tubular, disk-shaped or annular basic body, wherein the machining segments are connected to the basic body by welding, brazing or adhesive bonding. Depending on the machining method of the machining tool, machining segments that are used for core drilling are referred to as drilling segments, machining segments that are used for sawing are referred to as sawing segments, machining segments that are used for abrasive removal are referred to as abrading segments and machining segments that are used for cut-off grinding are referred to as cut-off grinding segments.

Machining segments for core drill bits, saw blades, abrasive disks and cut-off grinding chains are produced from a matrix material and hard material particles, where the hard material particles can be randomly distributed or arranged according to a defined particle pattern in the matrix material. In the case of machining segments with randomly distributed hard material particles, the matrix material and the hard material particles are mixed, and the mixture is poured into a suitable mold and further processed to form the machining segment. In the case of machining segments with set hard material particles, a green body is built up in layers from matrix material, in which the hard material particles are placed according to the defined particle pattern. In the case of machining segments that are welded to the basic body of the machining tool, the structure comprising a machining zone and a neutral zone has proven to be successful. The machining zone is built up from a first matrix material and the neutral zone is built up from a second matrix material, which is different from the first matrix material.

Machining tools that are designed as a core drill bit, saw blade, abrasive disk or cut-off grinding chain and are intended for the wet machining of concrete materials are only suitable to a limited extent for the dry machining of concrete materials. In the wet machining of concrete materials, an abrasive concrete sludge is produced, which is conducive to the machining process and leads to a self-sharpening of the machining segments during the machining. The matrix material is removed by the abrasive drilling sludge and new hard material particles are exposed. In the dry machining of concrete materials, no abrasive drilling sludge that could be conducive to the machining process can form. The hard material particles quickly become dull and the machining rate drops. Due to the lack of concrete sludge, the matrix material wears too slowly and deeper-lying hard material particles cannot be exposed. In the case of known machining tools for wet machining, the matrix material and the hard material particles have similar rates of wear.

The object of the present invention is to develop a machining segment for a machining tool that allows dry machining of concrete materials, wherein the machining segment is intended to have a high machining rate and as long a service life as possible.

The machining segment is characterized according to the invention in that at least one of the machining regions has with respect to the adjacent matrix regions a projection T₁ which is greater than 400 μm. The upper side of the machining segment is divided into machining regions, which comprise the first hard material particles, and matrix regions, which are made up of the first matrix material. The “first hard material particles” refer to the hard material particles of the machining segment according to the invention which are arranged in the machining regions on the upper side of the machining segment.

A machining segment in which at least one of the machining regions that comprise the first hard material particles has a projection with respect to the matrix regions of more than 400 μm is suitable for the dry machining of concrete materials. The greater the projection of the machining regions, the higher the machining rate that can be achieved with the machining segment.

A number of machining regions preferably have with respect to the adjacent matrix regions a projection T₁ that is greater than 400 μm. The greater the number of machining regions with first hard material particles that have a projection of more than 400 μm, the higher the machining rate of the machining tool during the dry machining of concrete materials.

Preferably, all of the machining regions have with respect to the adjacent matrix regions a projection T₁ that is greater than 400 μm. The greater the number of machining regions with first hard material particles that have a projection of more than 400 μm, the higher the machining rate of the machining tool during the dry machining of concrete materials.

In a preferred variant, the projection T₁ of the machining regions of at least 400 μm with respect to the adjacent matrix regions is provided in a front-side region of the machining regions, when considered in the direction of rotation of the machining tool. The machining of concrete materials with a machining segment according to the invention takes place in the front-side region of the machining regions with the first hard material particles, when considered in the direction of rotation. In order to achieve a high machining rate, the machining regions should have the projection of more than 400 μm with respect to the matrix regions in the front-side region.

Preferably, a front-side projection T_{front} of the machining regions in the front-side region of the machining regions differs from a rear-side region of the machining regions, as viewed in the direction of rotation of the machining tool. The machining of concrete materials with a machining segment according to the invention takes place in the front-side region of the machining regions with the first hard material particles, when considered in the direction of rotation. Since the rear-side region of the machining regions, as viewed in the direction of rotation, has only a small influence on the machining rate, the projection of the machining regions in the front-side region and in the rear-side region may be different.

Particularly preferably, a rear-side projection T_{back} of the machining regions in the rear-side region of the machining regions is less than 400 μm. Since the machining of concrete materials with a machining segment according to the invention takes place in the front-side region of the machining regions with the first hard material particles, the rear-side projection of the machining regions can take place with a view to secure fastening of the first hard material particles in the first matrix material.

In a further development of the machining segment, second hard material particles are arranged in the first matrix material, wherein an average particle diameter of the second hard material particles is less than an average particle diameter of the first hard material particles. Depending on the wear properties of the first matrix material, increased wear of the first matrix material on the side surfaces of the machining segment can occur during the machining of a concrete material with the machining tool as a result of friction with the base material (e.g. drill hole or sawing slit). The wear of the first matrix material can be reduced by second hard material particles. The second hard material particles can be admixed with the first matrix material as randomly distributed particles, or the second hard material particles are placed in the first matrix material according to a defined second particle pattern. The second hard material particles are placed in particular in the region of the side surfaces of the machining segment.

The invention also relates to a machining tool comprising a basic body and at least one machining segment according to the invention that is connected by an underside to the basic body of the machining tool.

In a first preferred variant, the machining tool takes the form of a core drill bit with a tubular basic body and a number of machining segments. The machining segments are connected by an underside to the tubular basic body of the core drill bit.

In a second preferred variant, the machining tool takes the form of a core drill bit with a tubular basic body and an annular machining segment. The machining segment is connected by an underside to the tubular basic body of the core drill bit.

In a third preferred variant, the machining tool takes the form of an annular or disk-shaped saw blade with an annular or disk-shaped basic body and a number of machining segments. The machining segments are connected by an underside to the annular or disk-shaped basic body of the annular or disk-shaped saw blade.

In a fourth preferred variant, the machining tool takes the form of an abrasive disk with a basic body and a number of machining segments. The machining segments are connected by an underside to the basic body of the abrasive disk.

Exemplary embodiments of the invention are described hereinafter with reference to the drawings. This is not necessarily intended to show the exemplary embodiments to scale; rather the drawings, where useful for explanation, are produced in a schematic and/or slightly distorted form. It should be taken into account here that various modifications and alterations relating to the form and detail of an embodiment may be undertaken without departing from the general concept of the invention. The general concept of the invention is not limited to the exact form or the detail of the preferred embodiment shown and described hereinafter or limited to subject matter that would be limited compared to the subject matter claimed in the claims. For given dimensioning ranges, values within the stated limits should also be disclosed as limit values and can be used and claimed as desired. For the sake of simplicity, the same reference numerals are used below for identical or similar parts or parts with identical or similar functions.

### BRIEF DESCRIPTION OF THE DRAWINGS

FIGS. 1A, 1B show two variants of a machining tool taking the form of a core drill bit;

FIGS. 2A, 2B show two variants of a machining tool taking the form of a saw blade;

FIG. 3 shows a machining tool taking the form of an abrasive disk;

FIG. 4 shows a machining tool taking the form of a cut-off grinding chain;

FIGS. 5A-C show a machining segment in a three-dimensional representation (FIG. 5A), in a view of an upper side (FIG. 5B), and in a view of a side surface (FIG. 5C); and

FIGS. 6A-C show some tool components that are used in the production of a machining segment.

### DETAILED DESCRIPTION OF THE DRAWINGS

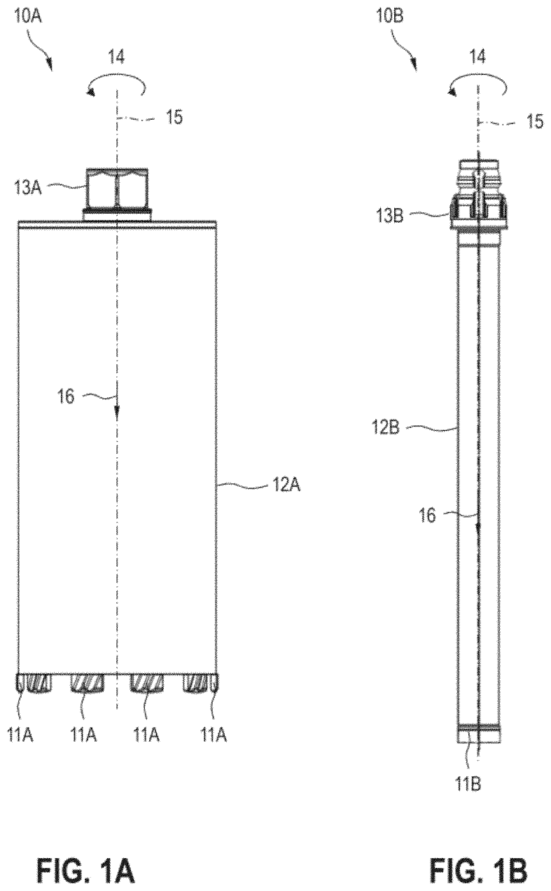

FIGS. 1A, 1B show two variants of a machining tool taking the form of a core drill bit 10A, 10B. The core drill bit 10A shown in FIG. 1A is referred to below as the first core drill bit, and the core drill bit 10B shown in FIG. 1B is referred to as the second core drill bit; in addition, the first and second core drill bits 10A, 10B are both included under the term “core drill bit”.

The first core drill bit 10A comprises a number of machining segments 11A, a tubular basic body 12A and a tool fitting 13A. The machining segments 11A, which are used for core drilling, are also referred to as drilling segments and the tubular basic body 12A is also referred to as a drilling shaft. The drilling segments 11A are fixedly connected to the drilling shaft 12A, for example by screwing, adhesive bonding, brazing or welding.

The second core drill bit 10B comprises an annular machining segment 11B, a tubular basic body 12B and a tool fitting 13B. The annular machining segment 11B, which is used for core drilling, is also referred to as a drilling ring, and the tubular basic body 12B is also referred to as a drilling shaft. The drilling ring 11B is fixedly connected to the drilling shaft 12B, for example by screwing, adhesive bonding, brazing or welding.

The core drill bit 10A, 10B is connected via the tool fitting 13A, 13B to a core drill and, in drilling operation, is driven by the core drill in a direction of rotation 14 about an axis of rotation 15. During the rotation of the core drill bit 10A, 10B about the axis of rotation 15, the core drill bit 10A, 10B is moved along a feed direction 16 into a workpiece to be machined, with the feed direction 16 running parallel to the axis of rotation 15. The core drill bit 10A, 10B creates a drill core and a drill hole in the workpiece to be machined.

The drilling shaft 12A, 12B in the exemplary embodiment of FIGS. 1A, 1B is formed in one piece and the drilling segments 11A and the drilling ring 11B are fixedly connected to the drilling shaft 12A, 12B. Alternatively, the drilling shaft 12A, 12B may be of a two-piece form, composed of a first drilling shaft section and a second drilling shaft section, with the drilling segments 11A or the drilling ring 11B being fixedly connected to the first drilling shaft section, and the tool fitting 13A, 13B being fixedly connected to the second drilling shaft section. The first and second drilling shaft sections are connected to one another via a releasable connection device. The releasable connection device takes the form, for example, of a plug-and-twist connection as described in EP 2 745 965 A1 or EP 2 745 966 A1. The formation of the drilling shaft as a one-piece or two-piece drilling shaft has no influence on the structure of the drilling segments 11A or of the drilling ring 11B.

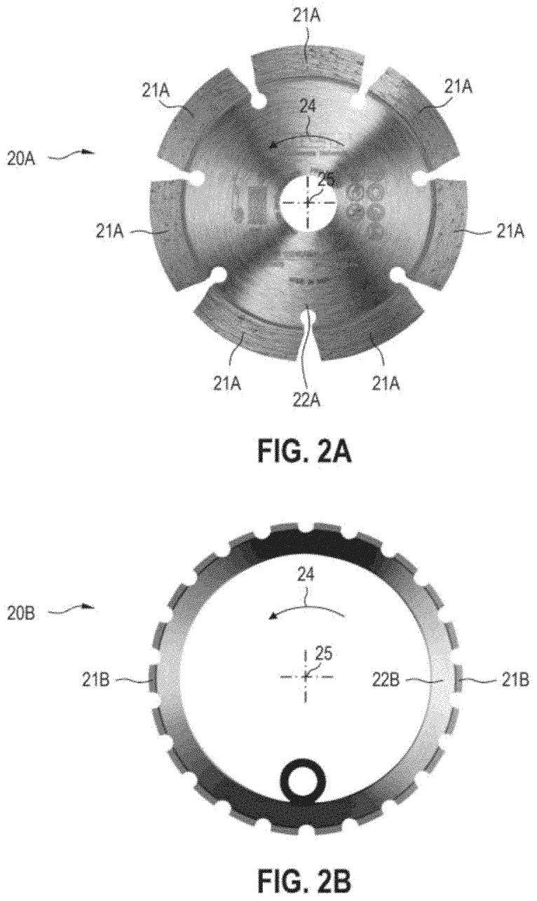

FIGS. 2A, 2B show two variants of a machining tool taking the form of a saw blade 20A, 20B. The saw blade 20A shown in FIG. 2A is referred to below as the first saw blade and the saw blade 20B shown in FIG. 2B is referred to as the second saw blade; in addition, the first and second saw blades 20A, 20B are both included under the term “saw blade”.

The first saw blade 20A comprises a plurality of machining segments 21A, a disk-shaped basic body 22A and a tool fitting. The machining segments 21A, which are used for sawing, are also referred to as sawing segments, and the disk-shaped basic body 22A is also referred to as a blade body. The sawing segments 21A are fixedly connected to the blade body 22A, for example by screwing, adhesive bonding, brazing or welding.

The second saw blade 20B comprises a plurality of machining segments 21B, an annular basic body 22B and a tool fitting. The machining segments 21B, which are used for sawing, are also referred to as sawing segments and the annular basic body 22B is also referred to as a ring. The sawing segments 21B are fixedly connected to the ring 22B, for example by screwing, adhesive bonding, brazing or welding.

The saw blade 20A, 20B is connected to a saw via the tool fitting and, in sawing operation, is driven by the saw in a direction of rotation 24 about an axis of rotation 25. During the rotation of the saw blade 20A, 20B about the axis of rotation 25, the saw blade 20A, 20B is moved along a feed direction, the feed direction running parallel to the longitudinal plane of the saw blade 20A, 20B. The saw blade 20A, 20B creates a sawing slit in the workpiece to be machined.

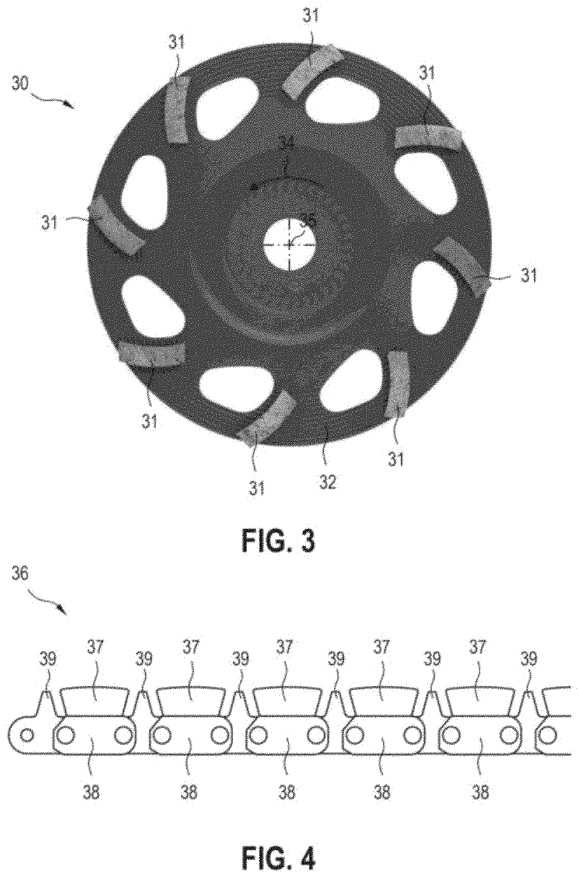

FIG. 3 shows a machining tool taking the form of an abrasive disk 30. The abrasive disk 30 comprises a number of machining segments 31, a basic body 32 and a tool fitting. The machining segments 31, which are used for abrasive removal, are also referred to as abrading segments, and the disk-shaped basic body 32 is also referred to as a pot. The abrading segments 31 are fixedly connected to the pot 32, for example by screwing, adhesive bonding, brazing or welding.

The abrasive disk 30 is connected via the tool fitting to a tool device and, in abrading operation, is driven by the tool device in a direction of rotation 34 about an axis of rotation 35. During the rotation of the abrasive disk 30 about the axis of rotation 35, the abrasive disk 30 is moved over a workpiece to be machined, the movement of the running perpendicular to the axis of rotation 35. The abrasive disk 30 removes the surface of the workpiece to be machined.

FIG. 4 shows a machining tool taking the form of a cut-off grinding chain 36. The cut-off grinding chain 36 comprises a number of machining segments 37, a number of basic bodies 38 in the form of links, and a number of connecting links 39. The machining segments 37, which are used for cut-off grinding, are also referred to as cut-off grinding segments, and the basic bodies 38 in the form of links are also referred to as driving links.

The driving links 38 are connected via the connecting links 39. In the exemplary embodiment, the connecting links 39 are connected to the driving links 38 via rivet bolts. The rivet bolts allow a rotation of the driving links 38 relative to the connecting links 39 about an axis of rotation which runs through the center of the rivet bolts. The machining segments 37 are fixedly connected to the driving links 38, for example by screwing, adhesive bonding, brazing or welding.

The cut-off grinding chain 36 is connected via a tool fitting to a tool device and, in operation, is driven by the tool device in a direction of rotation. During the rotation of the cut-off grinding chain 36, the cut-off grinding chain 36 is moved into a workpiece to be machined.

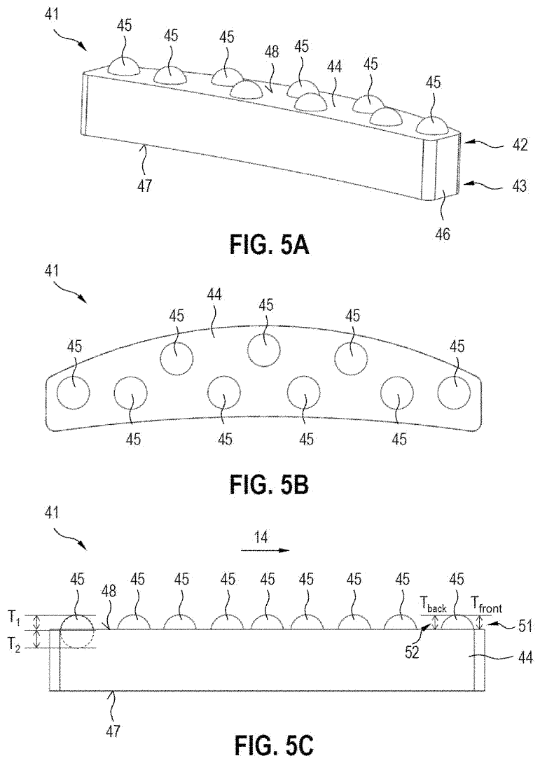

FIGS. 5A-C show a machining segment 41 according to the invention in a three-dimensional representation (FIG. 5A), in a view of an upper side of the machining segment 41 (FIG. 5B), and in a view of a side surface of the machining segment 41 (FIG. 5C).

The machining segment 41 corresponds in structure and composition to the machining segments 11A, 21A, 21B, 31, 37; the machining segment 11B taking the form of a drilling ring differs from the machining segment 41 by its annular structure. The machining segments can differ from one another in the dimensions and in the curvatures of the surfaces. The basic structure of the machining segments according to the invention is explained on the basis of the machining segment 41 and applies to the machining segments 11A, 11B of FIGS. 1A, 1B, to the machining segments 21A, 21B of FIGS. 2A, 2B, to the machining segment 31 of FIG. 3, and to the machining segment 37 of FIG. 4.

The machining segment 41 is built up from a machining zone 42 and a neutral zone 43. The neutral zone 43 is required if the machining segment 41 is intended to be connected to the basic body of a machining tool; in the case of machining segments which are connected to the basic body for example by brazing or adhesive bonding, the neutral zone 43 can be omitted. The machining zone 42 is built up from a first matrix material 44 and first hard material particles 45, and the neutral zone 43 is built up from a second matrix material 46 without hard material particles.

The machining segment 41 is connected by an underside 47 to the basic body of the machining tool. In the case of machining segments for core drilling and in the case of machining segments for abrasive removal, the underside of the machining segments is generally formed as planar, whereas the underside in the case of machining segments for sawing has a curvature in order to be able to fasten the machining segments to the curved end face of the annular or disk-shaped basic body.

The first hard material particles 45 are arranged in the first matrix material 44 according to a defined particle pattern. An upper side 48 of the machining segment 41 that is opposite from the underside 47 is divided into machining regions 51 and matrix regions 52, which are made up of the first matrix material 44. Each machining region 51 comprises a first hard material particles 45 and first matrix material 44, in which the first hard material particles 45 are embedded.

Since the first hard material particles 45 originate from a particle distribution between a minimum diameter and a maximum diameter, the proportion of the first matrix material 44 in the machining regions 51 can vary. It is the case here that the proportion of the first matrix material 44 in a machining region 51 increases if the diameter of the first hard material particle 45 decreases. In order to ensure that the first hard material particles 45 fit into the depressions of a special pressing punch during production, the cross section of the depressions is greater than the maximum diameter of the particle distribution.

The machining regions 51 of the machining segment 41 have a projection T₁ with respect to the matrix regions 52. In the exemplary embodiment of FIGS. 5A-C, the machining segment 41 comprises a number of 9 first hard material particles 45, and thus a number of 9 machining regions 51. The number of the first hard material particles 45 and the defined particle pattern in which the first hard material particles 45 are arranged in the first matrix material 44 are adapted to the requirements of the machining segment 41.

The machining tools according to the invention that are shown in FIGS. 1A, 1B, FIGS. 2A, 2B, FIG. 3 and FIG. 4 and are intended for the machining of concrete materials have a defined direction of rotation. As viewed in the direction of rotation of the machining tool, a distinction can be drawn between a front-side region and a rear-side region of a hard material particle 45.

The machining segment 41 can be produced, for example in a three-stage process: In a first stage, a green body is built up from the first matrix material 44 and the first hard material particles 45; in a second stage, the green body is compacted to form a compact body and, in a third stage, the compact body is further processed under the action of temperature or by infiltration to form the machining segment 41. The green body is compacted in the second stage for example by cold pressing or hot pressing. In the case of cold pressing, the green body is exclusively subjected to an action of pressure, while in the case of hot-pressing methods the green body is subjected not only to the action of pressure but also to temperatures of up to about 200° C. The compact body is further processed in the third stage, for example by sintering or hot-pressing, to form the machining segment.

The machining regions 51 are surrounded on the upper side 48 of the machining segment by the matrix regions 52, and the projection of a machining region 51 is measured with respect to the adjacent matrix regions. All of the machining regions have a projection with respect to the adjacent matrix regions 52. In this case, at least one of the machining regions 51 has a projection T₁ that is greater than 400 μm.

The direction of rotation 14 of the core drill bit 10A defines a front-side region 53 and a rear-side region 54. The machining of concrete materials takes place in the front-side regions 53 of the machining regions 51, and the machining rate essentially depends on the size of the projection of the machining regions 51 in the front-side regions 53. The machining regions 51 have in the front-side region 53 a front-side projection T_{front} and in the rear-side region 54 a rear-side projection T_{back}, which correspond in the exemplary embodiment. Alternatively, the machining regions 51 may have different front-side projections T_{front} and rear-side projections T_{back}.

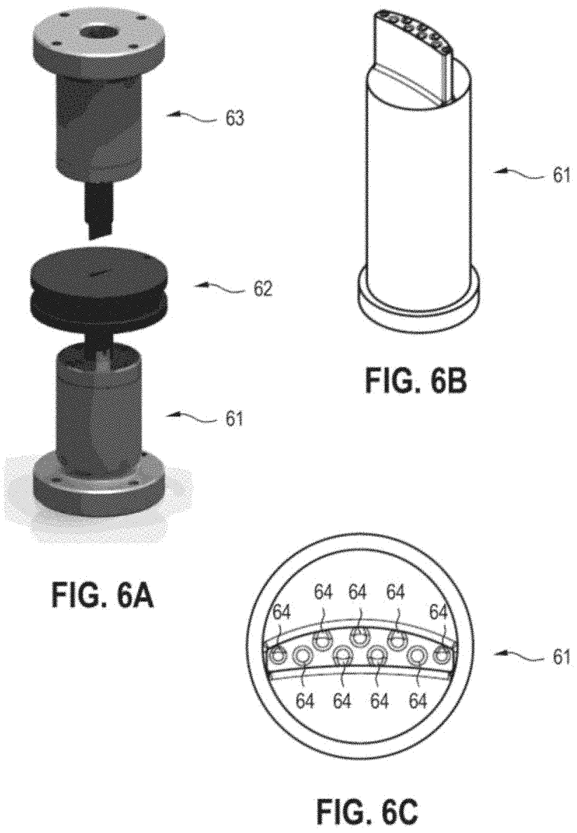

FIGS. 6A-C show some tool components that are used in the production of the machining segment 41 according to the invention. The tool components include a lower punch 61, a die-plate 62 and an upper punch 63, the lower punch 61 also being referred to as the first press punch and the upper punch 63 as the second press punch. FIGS. 6B and 6C show the lower punch 61 in detail.

The green body is built up in the die-plate 62 with a cross-sectional area that corresponds to the desired geometry of the green body. The die-plate 62 has on the underside a first opening, into which the lower punch 61 can be moved, and on the upper side a second opening, into which the upper punch 63 can be moved. The lower punch 61 has depressions 64 in the pressing surface, the arrangement of which corresponds to the defined particle pattern of the first hard material particles 45. The depressions 64 also determine the dimensions of the machining regions 51 on the upper side 48 of the machining segments.

With direct contact between the first hard material particles 45 and the depressions 64 of the lower punch 61, increased wear of the lower punch 61 may occur. In order to reduce the wear of the lower punch 61, direct contact of the first hard material particles 45 with the lower punch 61 should be avoided. Suitable measures are the application of a protective layer into the depressions 64 before the placement of the first hard material particles 45 and/or the use of encased first hard material particles 45.

In the exemplary embodiment, the green body is built up from top to bottom. Before the first hard material particles 45 are placed, a protective layer of the first matrix material 44 is applied into the depressions of the lower punch 61. Alternatively, a protective layer of a second matrix material may be applied into the depressions 64 of the lower punch 61, the second matrix material being different from the first matrix material 44. When a second matrix material that is different from the first matrix material 44 is used, matrix materials with different wear properties can be used. The second matrix material serves for protecting the lower punch 61 and should be able to be removed as quickly as possible from the finished machining segment in order to expose the first hard material particles 45 that machine the base material. A second matrix material with a higher wear rate than the first matrix material 44 can be removed quickly.

The first hard material particles 45 are placed in the depressions 64 of the lower punch 61. The first matrix material 44 is applied to the placed first hard material particles 45, wherein the first matrix material 44 can be applied in one layer or in a number of layers. The first matrix material 44 is poured into the die-plate 62 by means of a filling shoe until the desired filling height is reached. The finished green body is compacted under the action of pressure by means of the lower punch 61 and the upper punch 63 to form the compact body.

Instead of the protective layer that is applied in the depressions, coated first hard material particles may be used. The first matrix material 44 can be used as the casing material for the first hard material particles 45. Alternatively, a second matrix material may be used as the casing material for the first hard material particles 45, the second matrix material being different from the first matrix material 44. When a casing material that is different from the first matrix material 44 is used, matrix materials with different wear properties can be used. The casing material serves for protecting the lower punch 61 and should be able to be removed as quickly as possible from the finished machining segment in order to expose the first hard material particles 45 that machine the concrete material.

Machining segments, in which a protective layer of a second matrix material is applied or a second matrix material is used as a casing material for encased first hard material particles 45, additionally have second matrix material in the machining regions 51 or in the machining and matrix regions 51, 52.

Depending on the wear properties of the first matrix material 44, increased wear of the first matrix material 44 on the side surfaces of the machining segment can occur during the machining of a base material with the machining segment 41 as a result of friction with the base material. This wear can be reduced by second hard material particles. The second hard material particles can be admixed with the first matrix material 44 as randomly distributed particles, or the second hard material particles are placed in the first matrix material 44 according to a defined second particle pattern. The second hard material particles are placed in particular in the region of the side surfaces of the machining segment 41.

1.-12. (canceled)

13. A machining segment for a machining tool which is rotatable in a direction of rotation about an axis of rotation, comprising:
an underside, wherein the machining segment is connectable to a basic body of the machining tool by the underside;
a machining zone comprising a matrix material and a plurality of first hard material particles, wherein the plurality of first hard material particles are disposed in the matrix material in accordance with a defined particle pattern; and
an upper side, wherein the upper side is opposite from the underside and wherein the upper side is divided into a plurality of machining regions, which include respective ones of the plurality of first hard material particles, and a plurality of matrix regions which are built up from the matrix material;
wherein at least one of the plurality of machining regions has with respect to an adjacent matrix region a projection that is greater than 400 μm.

14. The machining segment as claimed in claim 13, wherein at least two of the plurality of machining regions have with respect to a respective adjacent matrix region a projection that is greater than 400 μm.

15. The machining segment as claimed in claim 13, wherein all of the plurality of machining regions have with respect to a respective adjacent matrix region a projection that is greater than 400 μm.

16. The machining segment as claimed in claim 13, wherein the projection is disposed in a front-side region of the at least one of the plurality of machining regions as viewed in the direction of rotation of the machining tool.

17. The machining segment as claimed in claim 16, wherein the projection disposed in the front-side region of the at least one of the plurality of machining regions differs from a rear-side region of the at least one of the plurality of machining regions as viewed in the direction of rotation of the machining tool.

18. The machining segment as claimed in claim 17, wherein a rear-side projection of the at least one of the plurality of machining regions in the rear-side region is less than 400 μm.

19. The machining segment as claimed in claim 13, wherein a plurality of second hard material particles are disposed in the matrix material and wherein an average particle diameter of the plurality of second hard material particles is less than an average particle diameter of the plurality of first hard material particles.

20. A machining tool, comprising:
a basic body; and
the machining segment as claimed in claim 13, wherein the machining segment is connected to the basic body by the underside of the machining segment.

21. The machining tool as claimed in claim 20 further comprising a plurality of machining segments as claimed in claim 13, wherein the machining tool is a core drill bit and wherein the basic body is a tubular basic body.

22. The machining tool as claimed in claim 20, wherein the machining tool is a core drill bit, wherein the basic body is a tubular basic body, and wherein the machining segment is an annular machining segment.

23. The machining tool as claimed in claim 20 further comprising a plurality of machining segments as claimed in claim 13, wherein the machining tool is an annular or disk-shaped saw blade and wherein the basic body is an annular or disk-shaped basic body.

24. The machining tool as claimed in claim 20 further comprising a plurality of machining segments as claimed in claim 13, wherein the machining tool is an abrasive disk.
